(19) United States
(12) Patent Application Publication
(10) Pub. No.: US 2011/0145730 A1
(43) Pub. Date: Jun. 16, 2011

(54) Utilization of Browser Space

(75) Inventor: Xin ZHOU, Beijing (CN)

(73) Assignee: Google Inc., Mountain View, CA (US)

(21) Appl. No.: 12/727,688

(22) Filed: Mar. 19, 2010

(30) Foreign Application Priority Data
Dec. 11, 2009 (CN) 200910259112.8

(51) Int. Cl. G06F 3/048

(52) U.S. Cl. 715/760; 715/781; 715/800

(57) ABSTRACT

Systems, methods and computer program products for utilization of browser space are described herein. An embodiment includes determining unused browser space on a display and selectively rendering one or more content items in the determined space based on dimensions of the display. The embodiment further includes, determining dimensions of a window in which the browser is displayed, wherein the dimensions include a height and a width of the window. Furthermore, the embodiment includes selectively displaying the content items in the unused browser space based on the width of the browser window, item width of each of the content items and a gap width between the content items. In this way, unused browser space on a display is effectively utilized by selectively rendering one or more content items in the unused browser space.

### CROSS REFERENCE TO RELATED APPLICATIONS

This patent application claims the benefit of Chinese Patent Application No. 200910259112.8 (Attorney Docket No. 2525.246CN00), filed Dec. 11, 2009, entitled “Utilization of Browser Space,” which is incorporated herein by reference in its entirety.

### BACKGROUND

1. Field

Embodiments of the present invention relate to web browsers, and particularly towards utilization of displayed browser space.

2. Background Art

Web-pages can be displayed on displays having different sizes and resolution levels. Conventionally, web-page designers design web-pages with fixed web-page dimensions. Such web-pages are configured for a specific display resolution.

When web-pages are displayed on displays set to a resolution level higher than a pre-configured web-page display resolution level, web-page content is centered in a small region within a browser window. As a result, a large area of the displayed browser window is under-utilized and may show no content.

### BRIEF SUMMARY

Embodiments of the present invention relate to utilization of displayed browser space. An embodiment includes determining unused browser space on a display and selectively rendering one or more content items in the determined space based on dimensions of the display. The embodiment further includes, determining dimensions of a window in which the browser is displayed, wherein the dimensions include a height and a width of the window. Furthermore, the embodiment includes selectively displaying the content items in the unused browser space based on the width of the browser window, item width of each of the content items and a gap width between the content items.

In this way, unused browser space on a display is effectively utilized by selectively rendering one or more content items in the unused browser space.

Further embodiments, features, and advantages of the invention, as well as the structure and operation of the various embodiments of the invention are described in detail below with reference to accompanying drawings.

### BRIEF DESCRIPTION OF THE DRAWINGS

Embodiments of the present invention are described with reference to the accompanying drawings. In the drawings, like reference numbers may indicate identical or functionally similar elements. The drawing in which an element first appears is generally indicated by the left-most digit in the corresponding reference number.

FIG. 1 is diagram illustrating a system for utilization of browser space, according to an embodiment.

FIGS. 2A-2B are diagrams illustrating an exemplary browser window, web-page and unused browser space.

FIG. 3A is a flowchart illustrating an exemplary overall operation of the system of FIG. 1, according to an embodiment.

FIG. 3B is a flowchart illustrating an operation of a dimension determiner, according to an embodiment.

FIG. 3C is a flowchart illustrating an operation of a rendering engine, according to an embodiment.

FIGS. 4A-4D are diagrams illustrating an exemplary browser window, web-page, content items and unused browser space, according to embodiments.

FIG. 5 illustrates an exemplary browser window with utilization of unused browser space, according to an embodiment.

FIG. 6 illustrates an example computer useful for implementing components of embodiments of the invention.

### DETAILED DESCRIPTION

Embodiments of the present invention relate to utilization of unused browser space are described herein. An embodiment includes determining unused browser space on a display and selectively rendering one or more content items in the determined space, based on dimensions of the display. The embodiment further includes, determining dimensions of a window in which the browser is displayed, wherein the dimensions include a height and a width of the window. Furthermore, the embodiment includes selectively displaying the content items in the unused browser space based on the width of the browser window, item width of each of the content items and a gap width between the content items.

In this way, unused browser space on a display is effectively utilized by selectively rendering one or more content items in the unused browser space.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

### System

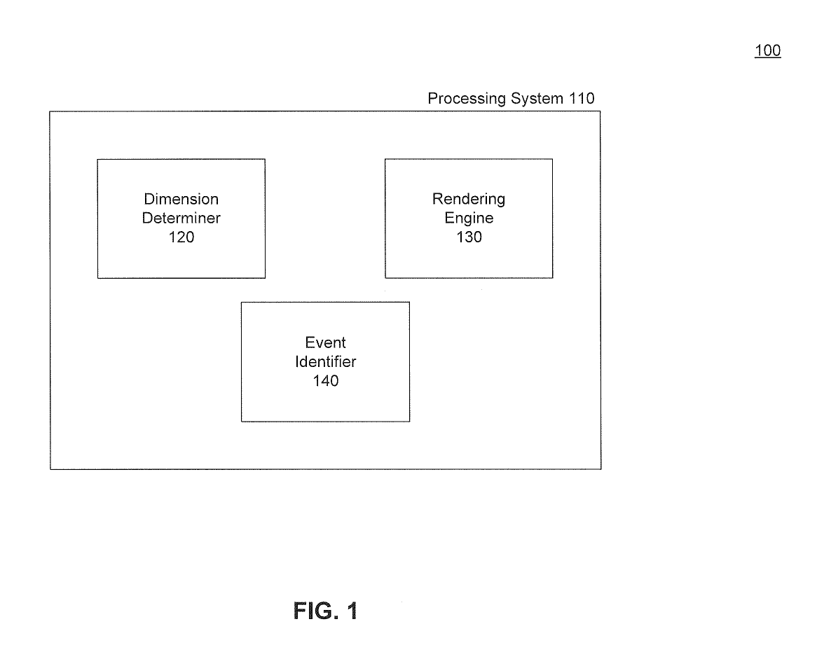

This section describes a system for utilization of unused browser space, according to an embodiment of the invention illustrated in FIG. 1. FIG. 1 is a diagram of system 100 for utilization of unused browser space. While the following is described in terms of web browser space, web-pages and websites, embodiments of the invention are not limited to this embodiment. Embodiments of the invention can be used in conjunction with other forms of non-web interfaces or file management interfaces. Furthermore, embodiments of the invention may be used to display content other than web-pages or websites. For example, embodiments of the invention can be used in any system having generally the structure of FIG. 1, or that would benefit from the operation, methods and functions as described herein. As used herein, the term ‘unused space’ refers to any space on a displayed browser window where content items (e.g. images or text) are not rendered. As an example, not intended to limit the invention, unused space may appear as a ‘blank’ or ‘white’ space on a browser window. As used herein, the term ‘content item’refers to images, animations, videos, web-pages or any other content that can be displayed on a display.

System 100 includes processing system 110. As shown in FIG. 1, processing system 110 further includes dimension determiner 120, rendering engine 130 and event identifier 140.

According to an embodiment, processing system 110 may be implemented on any device (or a plurality of devices) that can support graphics processing, web content retrieval and rendering. Such a device can include, but is not limited to, a personal computer, a group of networked computers, mobile device such as a mobile phone, workstation, embedded system, game console, television, set-top box, or any other computing device that can support computer graphics and content display. Such a device may include, but is not limited to, a device having one or more processors and memory for executing and storing instructions. Such a device may include software, firmware, and hardware. Software may include one or more applications and an operating system. Hardware can include, but is not limited to, a processor, memory and a display.

As discussed above, dimension determiner 120, rendering engine 130 and event identifier 140 may be implemented within processing system 110. In another embodiment, not intended to limit the invention, processing system 110 may be implemented within a browser, where the browser is implemented on a computing device (not shown). Such a computing device may include, but is not limited to, a device having one or more processors and memory for executing and storing instructions. Such a device may include software, firmware, and hardware. Software may include one or more applications and an operating system. Hardware can include, but is not limited to, a processor, memory and a display.

The operation of dimension determiner 120, rendering engine 130 and event identifier 140 is described further below.

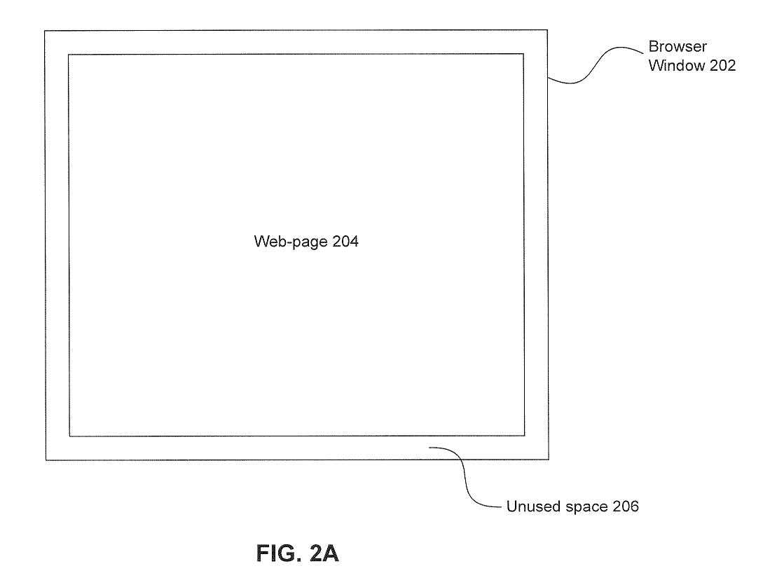

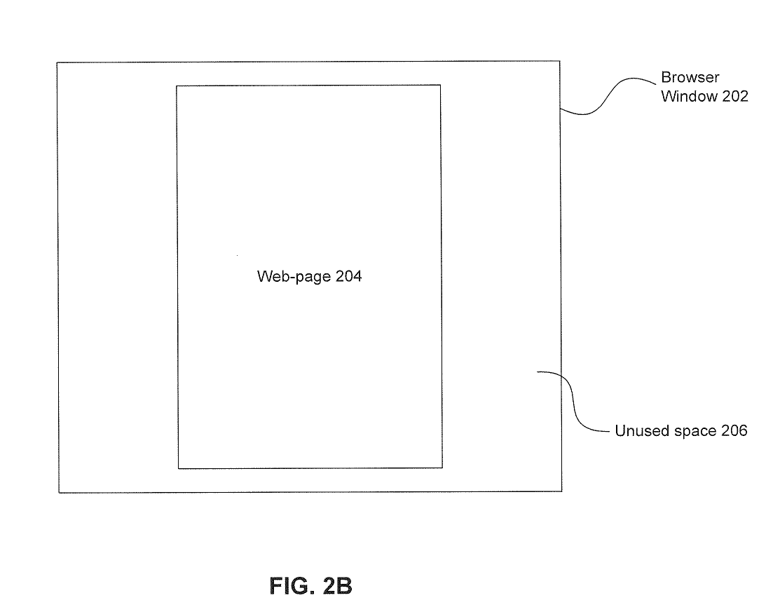

FIG. 2A illustrates exemplary browser window 202 and web-page 204 that may be displayed on a display (e.g. a CRT, LCD or LED display). As shown in FIG. 2A, there exists unused space 206 between browser window 202 and web-page 204. As discussed above, the term ‘unused space’ refers to any space on a displayed browser window where content items (e.g. images or text) are not rendered. As an example, not intended to limit the invention, unused space may appear as a ‘blank’ or ‘white’ space on a browser window.

FIG. 2B illustrates exemplary browser window 202 and web-page 204 that may be displayed on a display (e.g. a CRT, LCD or LED display) with a higher resolution compared to the display of FIG. 2A. When web-pages are displayed on screens set to a resolution level that may be higher than a pre-configured web-page resolution, web-page content is centered in a small region within a browser window. As a result, a large area of the displayed browser window is unused and may show no content. As shown in FIG. 2B, the amount of unused space 206 has increased in comparison to the unused space of FIG. 2A. Thus, web-page 204 is centered within browser window 202 leaving a greater amount of unused space 206 around web-page 204.

Embodiments of the invention overcome disadvantages of the display approach illustrated in FIG. 2B by rendering content in unused space 206. In an embodiment, dimension determiner 120 determines unused space 206 and rendering engine 130 selectively renders one or more content items in the determined unused space 206. Furthermore, in an embodiment, dimension determiner 120 receives notification of a browser window resize event from event identifier 140. Such a notification enables dimension determiner 120 to update its determination of unused space 206. For example, when a user increases the size of browser window 202, dimension determiner 120 may determined that unused space 206 has increased.

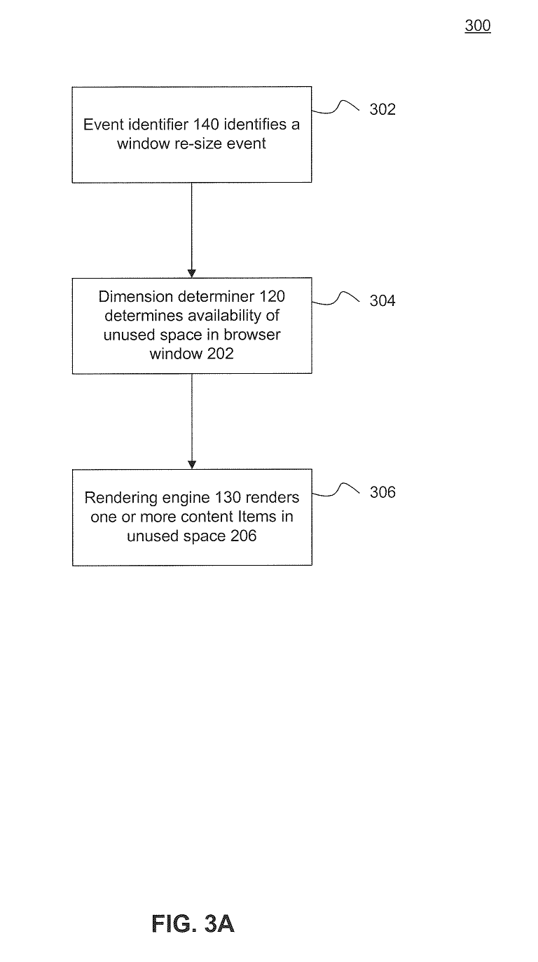

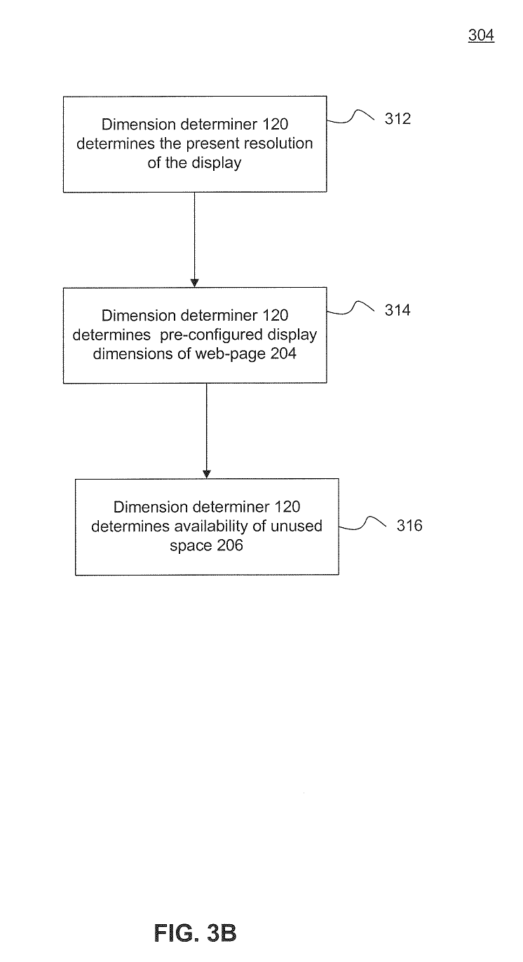

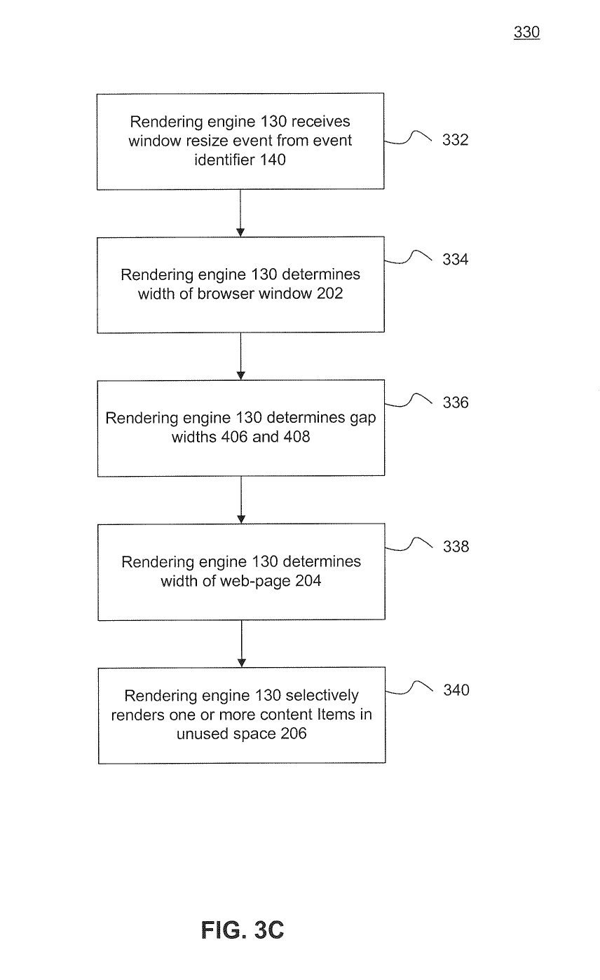

FIG. 3A is flowchart 300 illustrating an exemplary overall operation of processing system 110, according to an embodiment.

In step 302, event identifier 140 identifies a window resize event. For example, a window resize event may occur when a user resizes browser window 202 displaying web-page 204.

In step 304, dimension determiner 120 determines availability of unused space 206 in browser window 202. In an embodiment, not intended to limit the invention, the availability of unused space 206 may be determined if the present resolution of a display displaying browser window 202 is higher than pre-configured display dimensions for web-page 204. For example, if a display has a resolution of 1900×1200 pixels and web-page 204 is optimized by a user (e.g. web developer) for a display having a lower resolution of 1024×768 pixels, web-page 204 will occupy a smaller region of the 1900×1200 pixel display resulting in unused space 206 surrounding web-page 204 as shown in FIG. 2B. Step 304 is described in greater detail in flowchart 310 further below.

In step 306, rendering engine 130 renders one or more content items in unused space 206. As an example, content items can include images, animations, videos, web-pages or any other content that can be displayed on a display. The operation of rendering engine 130 is described in detail further below.

FIG. 3B is a flowchart illustrating step 304 of flowchart 300 in greater detail according to an embodiment.

In step 312, dimension determiner 120 determines the current resolution of a display displaying browser window 202. As an example, dimension determiner 120 determines the present resolution of a display (e.g. 1900×1200 pixels) displaying browser window 202.

In step 314, dimension determiner 120 determines a pre-configured resolution associated with web-page 204 that is displayed in browser window 202.

In step 316, dimension determiner 120 dimension determiner 120 determines the availability of unused space 206. For example, to determine availability of unused space 206, dimension determiner 120 determines if the present resolution of a display displaying a browser window 202 is higher than pre-configured display dimensions for web-page 204. If the present resolution of a display displaying a browser window 202 is higher than pre-configured display dimensions for web-page 204, dimension determiner 120 determines the availability of unused space 206. However, if the present resolution of a display displaying a browser window 202 not higher than pre-configured display dimensions for web-page 204, dimension determiner 120 may determine that unused space 206 is not available.

In this way, using method 310, dimension determiner 120 determines the availability of unused space 206.

Once availability of unused space 206 is determined by dimension determiner 120, rendering engine 120 may render one or more content items in unused space 206. As discussed above, content items can include images, animations, videos, web-pages or any other content that can be displayed on a display.

FIG. 3C is flowchart 330 illustrating an operation of rendering engine 130, according to an embodiment.

Method 330 begins with rendering engine 130 receiving a window resize event from event identifier 140 (step 332). Rendering engine 130 determines the width of browser window 202 (step 334). Rendering engine 130 determines gap widths 406 and 408 (step 336) and width of web-page 204 (step 338). As an example, not intended to limit the invention, rendering engine 130 determines widths of browser window 202 and gap widths 406 and 408 using web-scripting techniques known to those skilled in the art. For example, rendering engine 130 may use scripting methods such as “get.Width( )” to determine width of browser window 202, gap widths 406 and 408 as well as widths of content items 402-404 and web-page 204.

Rendering engine 130 then selectively renders one or more content items (e.g. content items 402 and 404) in unused space 206 (step 340). As an example, rendering engine 130 can use a plurality of exemplary conditions to render one or more content items in unused space 206. Exemplary display conditions used by rendering engine 130 are described further below.

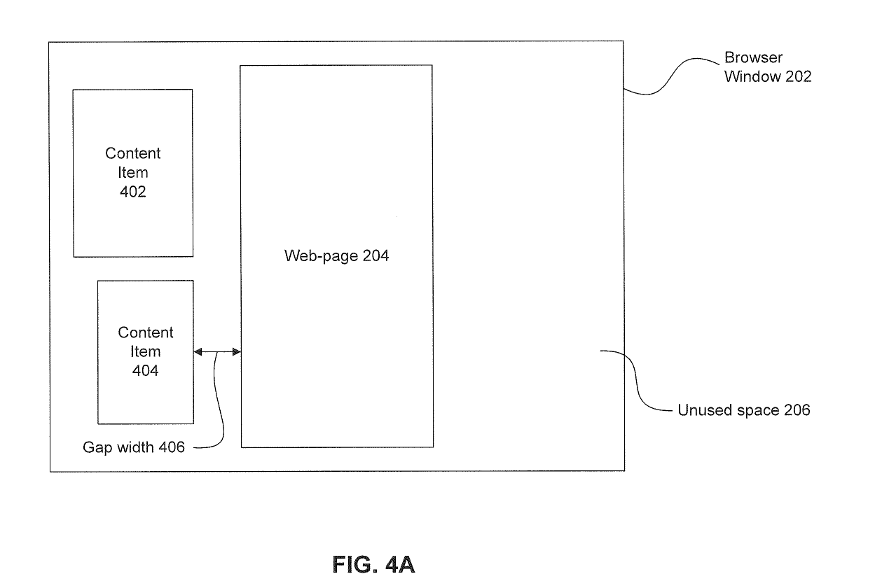

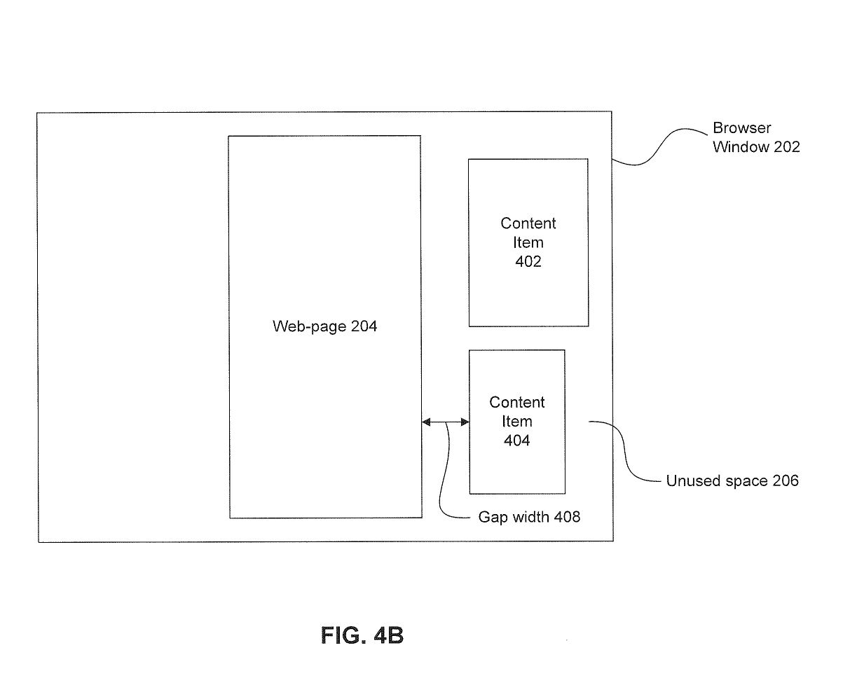

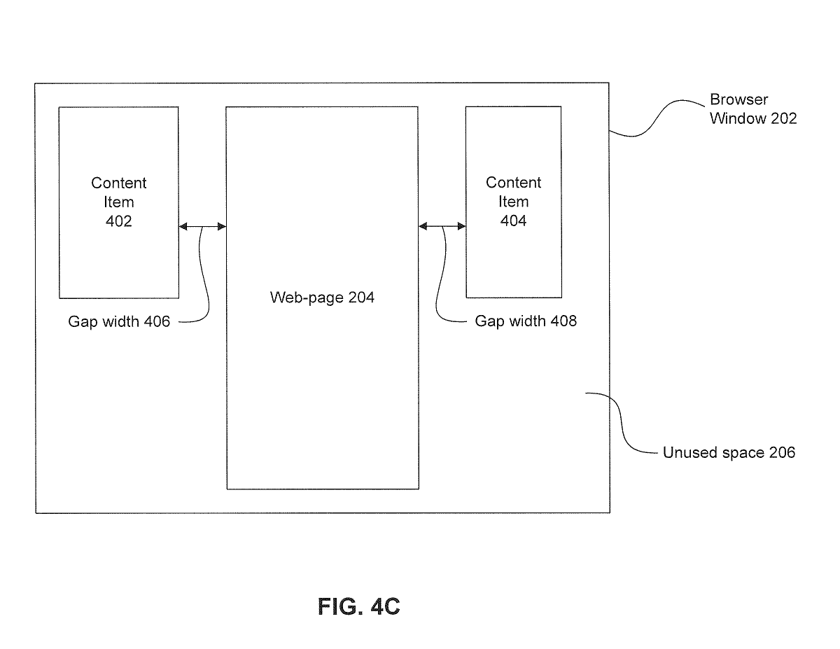

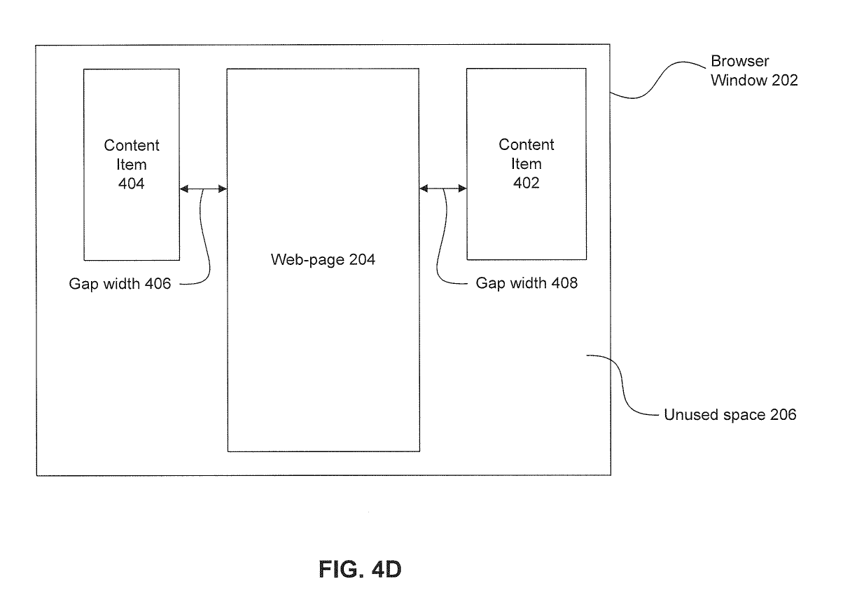

FIGS. 4A-4D illustrate display of content items 402 and 404 and web-page 204 in browser window 202. In an embodiment, rendering engine 130 selectively renders content items 402 and 404 in browser window 202. In an embodiment, rendering engine 130 uses a width of browser window 202, respective widths of content items 402 and 404 and gap width 406 between one or more of content items 402 and 404 and web-page 204, to selectively render content items 402 and 404 in browser window 202. The display arrangements that appear in FIGS. 4A-4D below are purely illustrative and are not intended to limit the invention.

FIG. 4A illustrates a first exemplary arrangement of content items 402 and 404 in browser window 202. In this exemplary scenario and in an embodiment, rendering engine 130 evaluates Exemplary Condition 1 shown below to selectively display content items 402 and 404 in browser window 202.

{One of[Width(Content item 402),Width(Content item 404)]+Gap Width 406+Width(Web-Page 204)}<Width(Browser Window 202) Exemplary Condition 1

Based on an evaluation of exemplary condition 1 shown above, rendering engine 130 selectively displays either content item 402 or content item 404 in browser window 202.

In another embodiment, not intended to limit the invention, rendering engine 130 evaluates exemplary condition 2 shown below. In particular, rendering engine 130 displays both content items 402 and 404 together or displays neither of content items 402 and 404.

{All of[Width(Content item 402),Width(Content item 404)]+Gap Width 406+Width(Web-Page 204)}<Width(Browser Window 202) Exemplary Condition 2

FIG. 4B illustrates a second exemplary arrangement of content items 402 and 404 in browser window 202. In this exemplary arrangement scenario, and in an embodiment, rendering engine 130 may evaluate Exemplary Condition 3 shown below to selectively display content items 402 and 404 in browser window 202.

{One of[Width(Content item 402),Width(Content item 404)]+Gap Width 408+Width(Web-Page 204)}<Width(Browser Window 202) Exemplary Condition 3

Based on an evaluation of exemplary condition 3 shown above, rendering engine 130 selectively displays either content item 402 or content item 404.

Referring back to the exemplary arrangement scenario illustrated in FIG. 4B, and in an embodiment, rendering engine 130 may also evaluate Exemplary Condition 4 shown below.

{All of[Width(Content item 402),Width(Content item 404)]+Gap Width 408+Width(Web-Page 204)}<Width(Browser Window 202) Exemplary Condition 4

Based on an evaluation of exemplary condition 4 shown above, rendering engine 130 displays both content items 402 and 404 together or displays neither of content items 402 and 404.

FIG. 4C illustrates a third exemplary arrangement of content items 402 and 404 in browser window 202. In an embodiment, rendering engine 130 evaluates Exemplary Condition 5 shown below to selectively display content items 402 and 404 in browser window 202.

{Width(Content item 402)+Width(Content item 404)+Gap Width 406+Gap Width 408+Width (Web-Page 204)}<Width(Browser Window 202) Exemplary Condition 5

Based on an evaluation of exemplary condition 5 shown above, rendering engine 130 may display both content item 402 and content item 404 together.

FIG. 4D illustrates a fourth exemplary arrangement of content items 402 and 404 in browser window 202. In this scenario, rendering engine 130 may also evaluate exemplary condition 5. For example, if exemplary condition 5 is true, rendering engine 130 displays both content items 402 and 404 together.

In this way, for example, rendering engine 130 displays one or more content items in unused space 206. It is to be appreciated that exemplary conditions 1-5 have been disclosed for the purposes of illustration and not limitation. Furthermore, for example, rendering engine 130 may show a number of content items in addition to content items 402 and 404. In an embodiment, rendering engine 130 determines exemplary conditions 1-5 at each browser window 202 resize event identified by event identifier 140. Because rendering engine 130 determines exemplary conditions 1-5 at each browser window 202 resize event identified by event identifier 140, rendering engine 130 is able to efficiently utilize unused space 206 in real time by selectively displaying one or more content items in unused spaced 206.

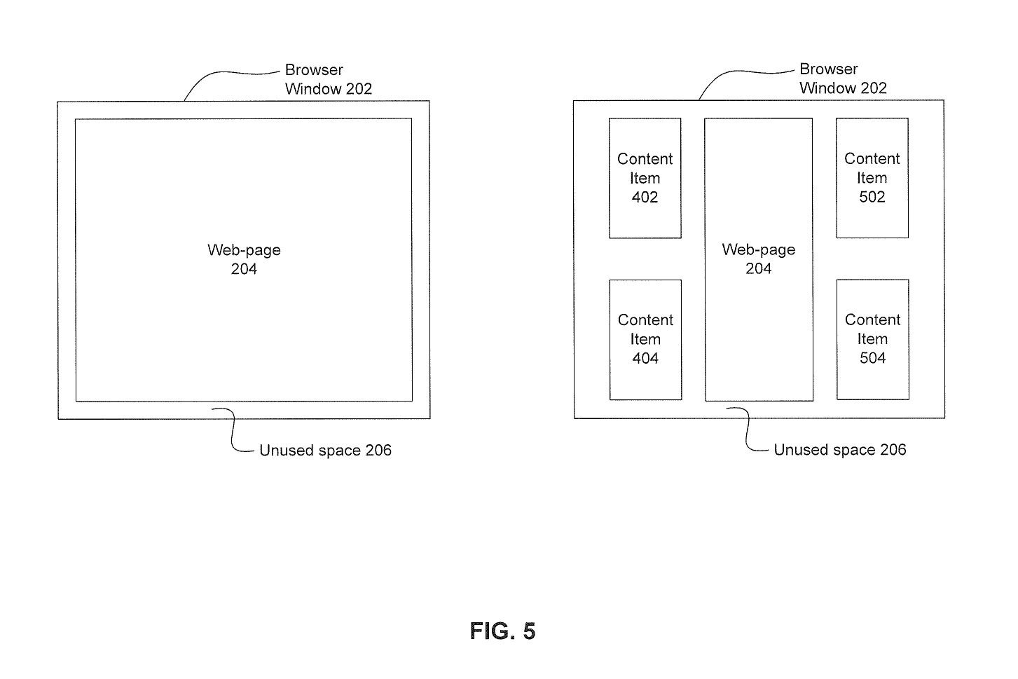

FIG. 5 illustrates contents of exemplary FIG. 2A and the effect of a window resize event on browser window 202. As shown in FIG. 5, when browser window is resized, rendering engine 130 displays one or more content items (e.g. content items 402, 404, 502 and 504 in unused space 206. It is apparent that embodiments of the invention have enabled utilization of unused browser space 206.

### Example Computer Embodiment

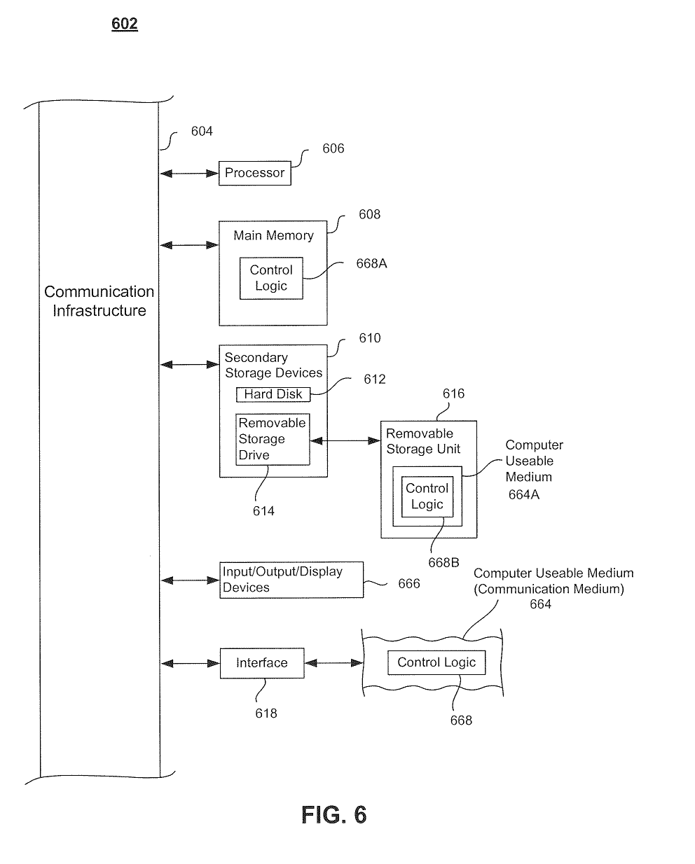

In an embodiment of the present invention, the system and components of embodiments described herein are implemented using well known computers, such as example computer 602 shown in FIG. 6. For example, processing system 110 can be implemented using computer(s) 602.

The computer 602 can be any commercially available and well known computer capable of performing the functions described herein, such as computers available from International Business Machines, Apple, Sun, HP, Dell, Compaq, Cray, etc.

The computer 602 includes one or more processors (also called central processing units, or CPUs), such as a processor 606. The processor 606 is connected to a communication infrastructure 604.

The computer 602 also includes a main or primary memory 608, such as random access memory (RAM). The primary memory 608 has stored therein control logic 668A (computer software), and data.

The computer 602 also includes one or more secondary storage devices 610. The secondary storage devices 610 include, for example, a hard disk drive 612 and/or a removable storage device or drive 614, as well as other types of storage devices, such as memory cards and memory sticks. The removable storage drive 614 represents a floppy disk drive, a magnetic tape drive, a compact disk drive, an optical storage device, tape backup, etc.

The removable storage drive 614 interacts with a removable storage unit 616. The removable storage unit 616 includes a computer useable or readable storage medium 664A having stored therein computer software 668B (control logic) and/or data. Removable storage unit 616 represents a floppy disk, magnetic tape, compact disk, DVD, optical storage disk, or any other computer data storage device. The removable storage drive 614 reads from and/or writes to the removable storage unit 616 in a well known manner.

The computer 602 also includes input/output/display devices 666, such as monitors, keyboards, pointing devices, etc.

The computer 602 further includes a communication or network interface 618. The network interface 618 enables the computer 602 to communicate with remote devices. For example, the network interface 618 allows the computer 602 to communicate over communication networks or mediums. The network interface 618 may interface with remote sites or networks via wired or wireless connections.

Control logic 668 may be transmitted to and from the computer 602 via the communication medium 664.

Any tangible apparatus or article of manufacture comprising a computer useable or readable medium having control logic (software) stored therein is referred to herein as a computer program product or program storage device. This includes, but is not limited to, the computer 602, the main memory 608, secondary storage devices 610 and the removable storage unit 616. Such computer program products, having control logic stored therein that, when executed by one or more data processing devices, cause such data processing devices to operate as described herein, represent embodiments of the invention.

Embodiments of the invention can work with software, hardware, and/or operating system implementations other than those described herein. Any software, hardware, and operating system implementations suitable for performing the functions described herein can be used. Embodiments of the invention are applicable to both a client and to a server or a combination of both.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method for utilization of browser space, comprising:
determining unused browser space on a display; and
selectively rendering one or more content items in the deter pined space based on a resolution of the display,
wherein the determining and the rendering steps are performed using one or more processors.

2. The method of claim 1, further comprising:
determining dimensions of a window in which the browser is displayed, wherein said dimensions include a height and a width of the window.

3. The method of claim 2, further comprising:
identifying a window resize event; and
determining the dimensions of the window based on the identifying step.

4. The method of claim 1, wherein the rendering comprises:
determining a browser width of the browser window;
determining a item width of each of the content items; and
determining a gap width between the content items and a web-page displayed in the browser window.

5. The method of claim 4, further comprising:
selectively displaying the content items in the unused browser space based on the browser width, the item width and the gap width.

6. A computer based system for utilization of browser space, comprising:
one or more processors;
a dimension determiner to determine unused browser space on a display; and
a rendering engine to selectively render one or more content items in the determined space based on a resolution of the display,
wherein the dimension determiner and the rendering engine are implemented using the one or more processors.

7. The system of claim 6, wherein the rendering engine further comprises:
an event identifier to identify a window resize event.

8. An article of manufacture including a computer-readable medium having instructions stored thereon that, if executed by a computing device, cause said computing device to perform operations comprising:
determining unused browser space on a display; and
selectively rendering one or more content items in the determined space based on a resolution of the display.

9. The article of manufacture of claim 8, the operations further comprising:
determining dimensions of a window in which the browser is displayed, wherein said dimensions include a height and a width of the window.

10. The article of manufacture of claim 9, the operations further comprising:
identifying a window resize event; and
determining the dimensions of the window based on the identifying step.

11. The article of manufacture of claim 8, the operations further comprising:
determining a browser width of the browser window;
determining a item width of each of the content items; and
determining a gap width between the content items and a web-page displayed in the browser window.

12. The article of manufacture of claim 11, the operations further comprising:
selectively displaying the content items in the unused browser space based on the browser width, the item width and the gap width.
